(19) United States
(12) Patent Application Publication
(10) Pub. No.: US 2010/0005624 A1
(43) Pub. Date: Jan. 14, 2010

(54) Handle assistance device for pull cord

(76) Inventors: Steven Swearingen, Shelton, WA (US); Therin G. Laney, Shelton, WA (US)

Correspondence Address: Douglas E. Mackenzie, P.O. Box 1295, Mt. View, CA, 94042, US

(21) Appl. No.: 12/080,394

(22) Filed: Apr. 1, 2008

(51) Int. Cl. B25G 1/00

(52) U.S. Cl. 16/110.1

(57) ABSTRACT

The present invention is directed to an aid designed to control the free-end of a pull cord element such that effectors that cause failure of the pull cord element itself are generally avoided such as by the aid being temporarily affixed to a metallic object up and away from dirt, water and oil.

### PARENT REFERENCE

Not Applicable

### BACKGROUND

Applications exist wherein an operable device required to affect a change in environment or to perform a specific function, wherein the device is necessarily located at a height that is not easily accessible to an operator or user of that device. When such an operable device has manually operated function, trigger or switch, and it is not otherwise feasible to render that function operable through an electronic means, it then becomes necessary to mechanically extend that manually operated function to the point where an operator or user can easily manipulate that function from a remote location. Typically, a simple means for mechanically extend a manual operation is through the use of a pull cord.

Pull cords are generally fabricated of natural or synthetic materials that are suitably strong for repeated use and yet are sufficiently conformable or flexible to allow an operator to manipulate the pull cord without discomfort. Further, when a pull cord is used in conjunction with a device whereby the device changes location or angle through employing force upon the pull cord by the operator, such as opening or closing of a mechanical-type roll-up door or awning, the pull cord must be fabricated of a material that is capable of supporting repeated changes in angle and force vector without failure. Multiple ply ropes, cords, and straps formed of sisal, polyolefins, polyesters and cotton are representative of materials used in fabricating pull cords which are strong yet compliant.

The useful life span of a pull cord is defined by the composition and mode of fabrication of the material used in the pull cord construction. This lifespan is significantly reduced when the pull cord is exposed to additional friction, elongation forces, and environmental effectors. As the pull cord is typically extending from an operable device through free space to a point where it can be manipulated by an operator, it is common place that other objects being moved through that same space can become entwined with the pull cord. When the pull cord becomes entwined with a separate object, the pull cord is exposed to abrasion and momentary elongation forces which compromise the durability of the pull cord. Further, when the pull cord comes into contact with a work surface such a work bench, driveway, garage floor and the like, the pull cord can become entrained with materials that deteriorate the pull cord material through mechanical and/or chemical action. Pull cords which come in protracted contact with a surface, particularly a lower surface such as the ground, the pull cords can come under insect and vermin attack, especially when the pull cord is comprised of a natural fiber because of the nutritive factor of the composition or a fiber that is of interest due to use by vermin as a nesting material.

Heretofore, there is no apparent and direct resolution of issues that otherwise compromise the useful lifespan of a pull cord. There remains an unmet need to obviate the damages caused by inadvertent engagement of a pull cord by objects and to aid in retaining the pull cord out of direct or prolonged contact with mechanical, chemical, or organic deterioration sources.

### SUMMARY OF THE INVENTION

The present invention is directed to an aid for manually manipulating a pull cord element, and specifically, an aid for manually manipulating a pull cord element wherein a free end of the pull cord element can be temporarily affixed to a metallic object.

Many devices include a pull cord element as a means for actuating or controlling the respective device, including the turning on or off of electronic devices such as a garage door openers or light fixtures, as well as, for the operation of mechanical devices such affecting closure of mechanical roller-type door (either for a building or a container truck) or window/porch awning. The pull cord element has a first end that is permanently affixed to the device and a second end that is free hanging and generally within grasp of an operator. This free end of the pull cord element by its nature is typically extending into free space wherein the pull cord can become engaged in and interfere with other devices or objects that pass within close proximity to the free end. Further, the pull cord element may become relocated through transfer of the device from a first to a second position, such as the closing of a mechanical roller-type door, wherein the pull cord element is affixed to the leading edge of the door itself. After the door is closed, the free end of the pull cord element is typically then in direct contact with a lower surface such as the ground or drive-way. When the pull cord element and particularly the free end of the pull cord element is left in contact with a lower surface, the free-end can become entrained with water, dirt and debris and may become deleteriously entwined with other objects.

Protracted exposure to environmental conditions such as water, grit, solvents and vermin, combined by damage imparted by entwinement or engagement with other objects, can lead to failure of the pull cord and thereby create a dangerous operational situation for an operator whereby the pull cord can break and cause loss of control or operation of the device. The present invention is directed to an aid designed to locate and control the free-end of a pull cord element such that effectors that cause failure of the pull cord element itself are generally avoided. The aid comprises a grasping handle, a cord retention element, and at least one magnetic pad. When employed on the free end of a pull cord element, the pull cord can be drawn away by an operator and temporarily affixed by the integrated magnetic pad to a suitable ferrous metallic object. By controlling the exact location of the free end of the pull cord, the operator can significantly reduce the potential for the pull cord to become entwined with other objects.

A further embodiment of the pull cord handle of the present invention is the use of the magnetic pad to retain the free end up and away from inadvertent or protracted contact with soiled or contaminated work surfaces. For example, when employed on the leading edge of a mechanical-type roller door, once the operator closes the door, the free end of the pull cord can be temporarily affixed by the magnetic pad in the handle assistance device to the door construction itself at a point that is above ground level and is additionally readily accessible to the operator for reopening the door at a later time.

It is further within the purview of the present invention that the handle assistance device may include at least one attention garnering function such that an operator can easily locate the free end of the pull cord in order to operate a remotely located functional device.

### BRIEF SUMMARY OF THE FIGURES

The invention will be more easily understood by a detailed explanation of the invention including drawings. Accordingly, drawings which are particularly suited for explaining the inventions are attached herewith; however, it should be understood that such drawings are for descriptive purposes only and as thus are not necessarily to scale beyond the measurements provided. The drawings are briefly described as follows:

FIG. 1 is a right side view of a representative handle assistance device in accordance with the present invention

FIG. 2 is a left side view of a representative handle assistance device

FIG. 3 is a front view of a representative handle assistance device.

FIG. 4 is a back view of a representative handle assistance device.

FIG. 5 is a top-down view of a representative handle assistance device.

FIG. 6 is a bottom-up view of a representative handle assistance device.

FIG. 7 is a perspective view of a representative handle assistance device being used by an operator to locate a pull cord extending from a remote location to an easily accessible location essentially free of deleterious entwinement with passing objects.

FIG. 8 is a right side view of a representative handle assistance device in accordance with the present invention wherein the handle assistance device further includes an attention garnering feature

FIG. 9 is a left side view of a representative handle assistance device with an attention garnering feature.

FIG. 10 is a front view of a representative handle assistance device with an attention garnering feature.

FIG. 11 is a back view of a representative handle assistance device with an attention garnering feature.

FIG. 12 is a proximal end, top-down view of a representative handle assistance device with an attention garnering feature.

FIG. 13 is a distal end, bottom-up view of a representative handle assistance device with an attention garnering feature.

FIG. 14 is a panel of three end views of a handle assistance device as depicted in FIG. 1 wherein the free end of a pull cord is drawn through the cord retention element of the handle assistance device and knotted so as to prevent withdraw of the free end.

FIG. 15 is a panel of three end views of a handle assistance device as depicted in FIG. 1 wherein the free end of a pull cord is drawn through the cord retention element of the handle assistance device and a durable clip applied so as to prevent withdraw of the free end.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

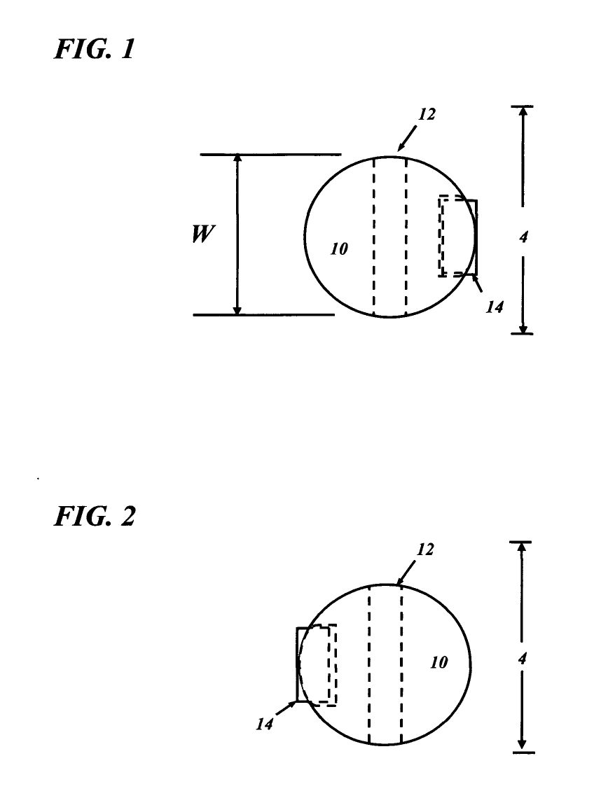

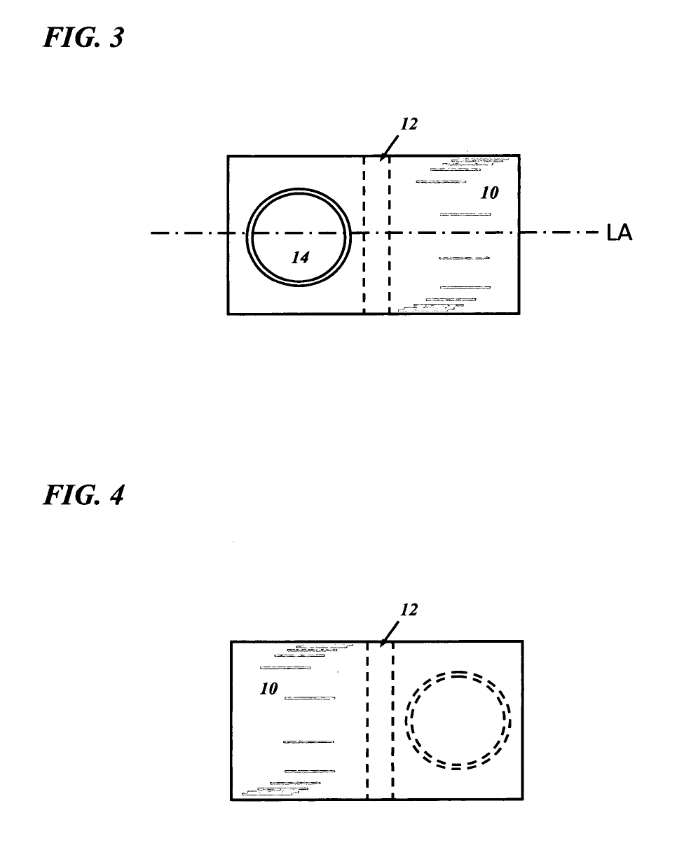

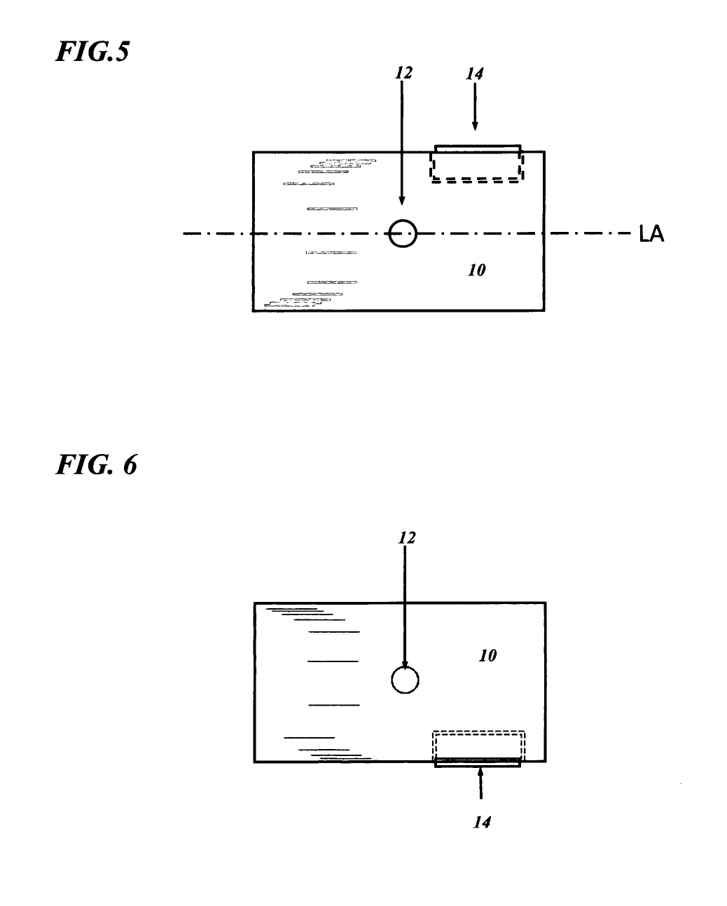

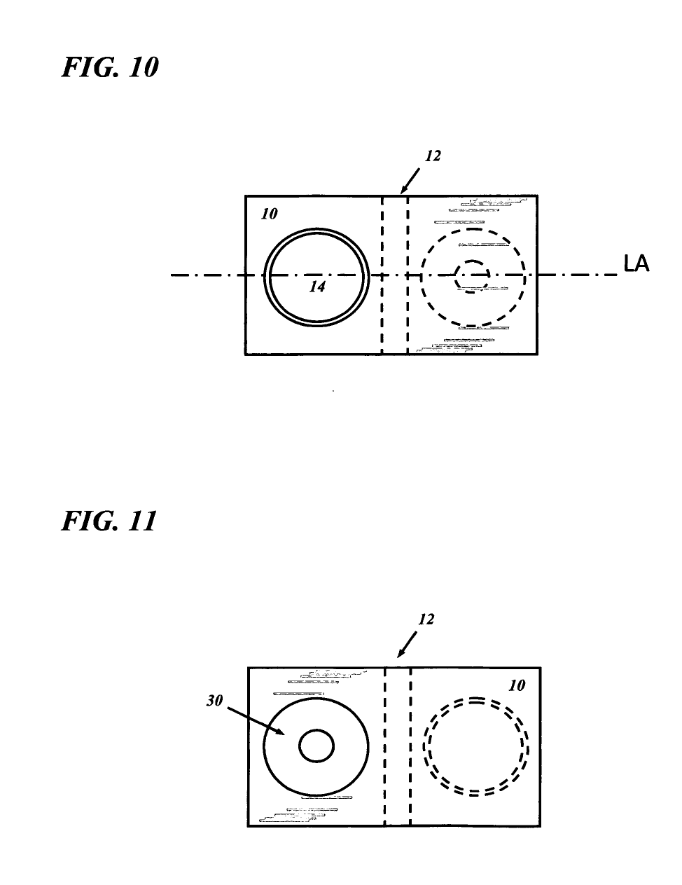

The present invention is directed to an aid designed to locate and control the free-end of a pull cord element such that effectors that cause failure of the pull cord element itself are generally avoided. As depicted in FIGS. 1 through 11, and specifically in FIG. 1, the handle assistance device 4 comprises a grasping handle 10, a cord retention element 12, and at least one magnetic pad 14.

Grasping handle 10 is constructed of suitably durable material such a plastic polymers or nonferrous materials such as polyvinylchloride, ABS, nylon, polycarbonate, and aluminum. The design of grasping handle is depicted wherein a long axis (LA) of the handle is perpendicular to a free end of a pull cord 20. Grasping handle 10 is not constrained by profile or cross-sectional geometry so long as grasping handle has the general attribute of being easily manipulated by the human hand.

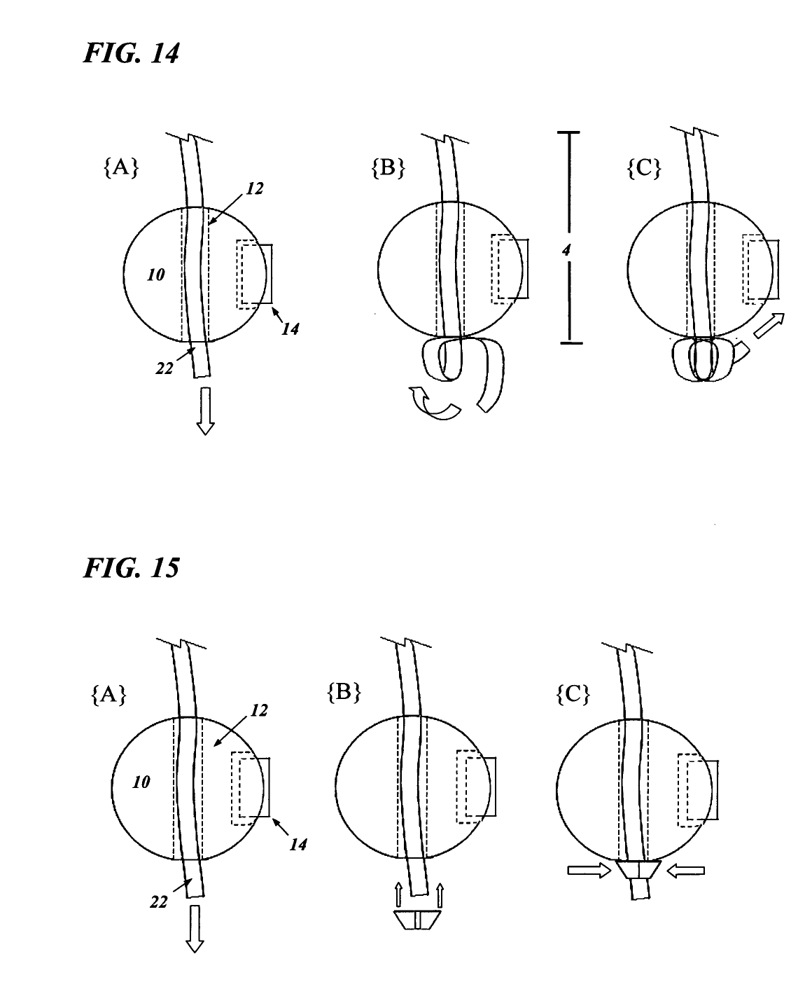

Grasping handle 10 includes an integrated cord retention element 12. Cord retention element is configured at the time of handle assistance device 4 manufacture to correspond to the dimensions of the intended cross-section of the pull cord 20 and may completely circumscribe pull cord 20 or may only surround a fraction of the total circumference of the pull cord 20. In the representative case as shown in FIG. 1, cord retention element is a circular hole slightly larger than pull cord which extends through the width (W) of grasping handle 10. When a through hole is used, the pull cord is inserted into and drawn through cord retention element 12 and either knotted (FIG. 14) or a separate clip durably affixed (FIG. 15) to increase the diameter of pull cord 20 and thereby prevent pull cord 20 from slipping back or withdrawing through cord retention element 12.

In the alternative, when pull cord 20 is intended to be a strap or web having a thickness and a width, cord retention element 12 may be an equivalent slot extending through the width (W) of grasping handle 10. When a through slot is used, the pull cord is inserted into and drawn through cord retention element 12 and a separate clip durably affixed to increase the cross-sectional dimension of pull cord 20 and thereby prevent pull cord 20 from slipping back through cord retention element 12.

Cord retention element 12 can include other means for retaining an associated pull cord 20 such as mechanical engagement against (e.g. a frictional barb or grate) or through (e.g. screw or rivet) pull cord 20 into the body of grasping handle 10. It is also possible to use in conjunction with, or in lieu of, a mechanical means, a chemical adhesive and/or thermal deformation of pull cord 20 to prevent loss of retention by handle assistance device 4.

In order to allow handle assistance device 4 to be temporarily affixed to a metallic or ferrous object, handle assistance device 4 further comprises at least one magnetic pad 14. Magnetic pad 14 is durably attached to handle assistance device 4 such that magnetic pad 14 is capable of interacting with ferrous surfaces positioned proximal thereto. Magnetic pad 14 can be either exposed and visible from an exterior viewing angle or contained within the confines of handle assistance device 4, whereby the enclosed magnetic pad 14 can be isolated from impact, shock, and chemical degradation. Magnetic pad 14 can include a plurality of individual magnets that are positioned to engage the same or opposite sides of handle assistance device 4 onto a ferrous structure. Further, handle assistance device 4 may include a plurality of magnetic pad 14 located at different points and/or on different sides of the handle assistance device construct so that the free end of the pull cord 20 can be engaged in multiple directional relationships of handle assistance device 4.

Suitable magnetic compositions for use in magnetic pad 14 are discussed in Wayne M. Saslow, “Electricity, Magnetism, and Light”, Academic (2002). ISBN 0-12-619455-6., hereby incorporated by reference, and include the following:
a) Ceramic, or ferrite, magnets are made of a sintered composite of powdered iron oxide and barium/strontium carbonate ceramic. The resulting magnets are noncorroding, but brittle and consideration must be given to isolating the magnetic pad 14 from impact such as by application of thin rubber membrane.
b) Alnico magnets are made by casting or sintering a combination of aluminum, nickel and cobalt with iron and small amounts of other elements added to enhance the properties of the magnet. Sintering offers superior mechanical characteristics, whereas casting delivers higher magnetic fields and allows for the design of intricate shapes. Alnico magnets resist corrosion and more resistance to shock or impact than ferrite.
c) Ticonal magnets are an alloy of titanium, cobalt, nickel, and aluminum, with iron and small amounts of other elements.
d) Injection molded magnets are a composite of various types of resin and magnetic powders, allowing parts of complex shapes to be manufactured by injection molding. The physical and magnetic properties of the product depend on the raw materials, but are generally lower in magnetic strength and resemble plastics in their physical properties.
e) Flexible magnets are similar to injection molded magnets, using a flexible resin or binder such as vinyl, and produced in flat strips or sheets. These magnets are lower in magnetic strength but can be very flexible, depending on the binder used.
f) Rare earth magnet (lanthanoid), and the preferred embodiment for the present invention, are chemically structured such that a very high amount of electrons can be accommodated, thus resulting in a very strong magnetic field. Common types of rare earth magnets are samarium-cobalt and neodymium-iron-boron (NIB) magnets.

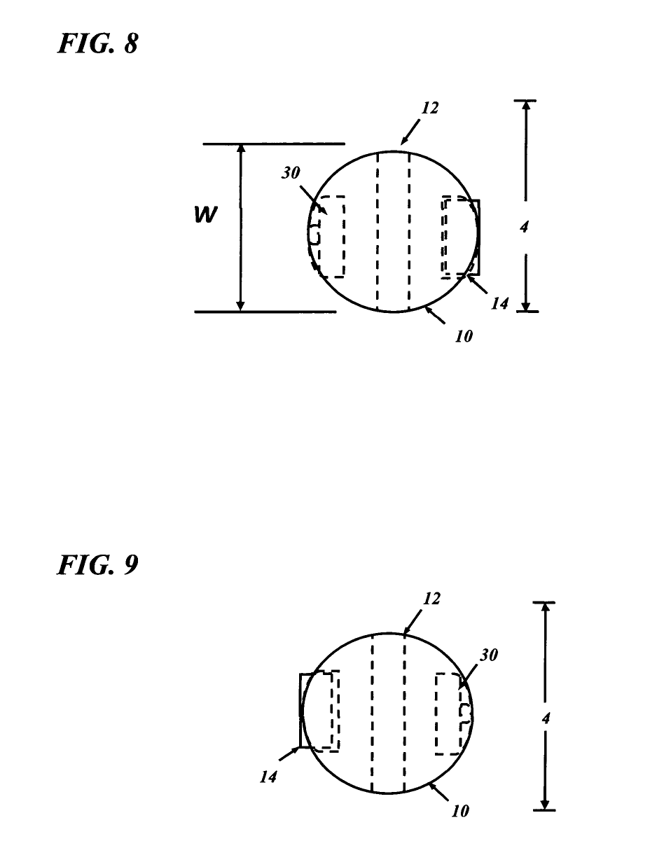

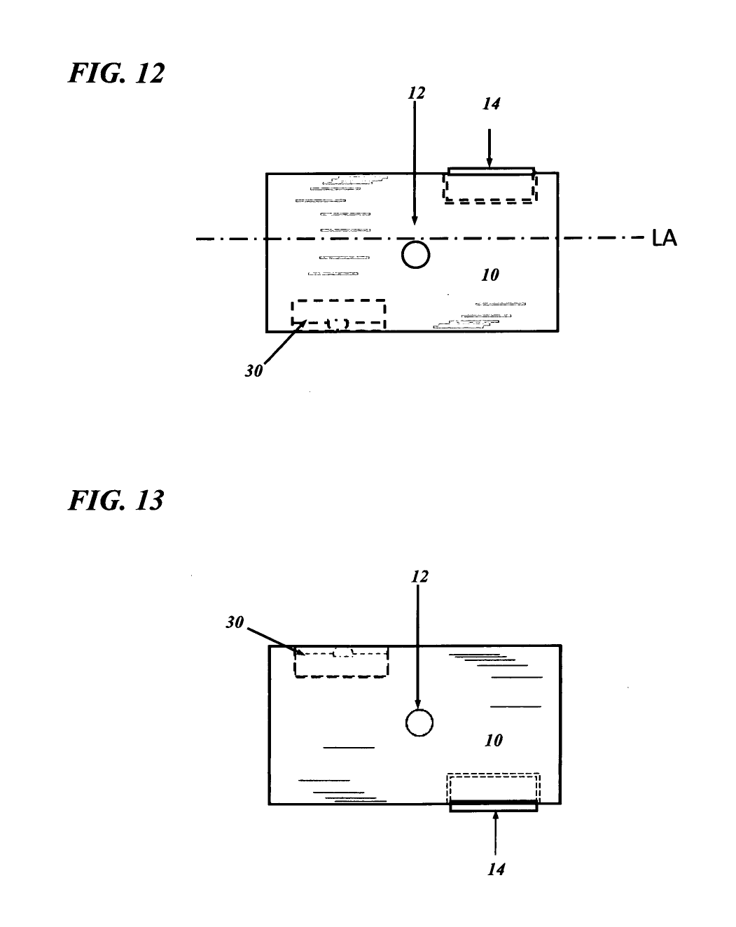

FIGS. 8 through 13 depict a handle assistance device 4 having a grasping handle 10, a cord retention element 12, at least one magnetic pad 14 and at least one attention garnering function 30. Attention garnering function 30 can include such attributes as visual and/or auditory alerts which allow an operator to quickly locate the free end of a pull cord in darkened, noisy, or otherwise compromised environments. Visual alerts include, but are not limited to, reflectance of ambient light sources, continuous or intermittent emission of a light source, alternation between two or more distinct visual wavelengths, and the combinations thereof. The visual alert can be passive such as a reflector or luminous paint or a phosphorescent chemistry integrated into the material composition of the handle assistance device 4. In the alternative, the visual alert can be active and utilize a power source, such as a battery, to operate incandescent or light emitting diodes (LED's) to generate a lighting effect. Suitable auditory alerts include continuous or intermittent tones of same or changing frequency and/or amplitude. The attention garnering function 30 may be manually operated into an ON/OFF state through use of a switch (not shown), may be in continuous operation, or may be switched to an ON state by completion of a circuit when magnetic pad 14 engage a metal surface and switched to an OFF state by removal of the integrated magnetic pad 14 from the metal surface.

It should be noted that use of visual alerts are especially suited for individuals who may have compromised hearing capability to be able to locate the free end of a pull cord. Conversely, auditory alerts are especially suited allowing for individuals who may have compromised visual capability to locate the free end of a pull cord. Through the use of magnetic pad 14 to temporarily affix the free end of a pull cord to a specific location, individuals having disabilities in visual or auditory capability may locate the free end of the pull cord at a position of known and repeatable location.

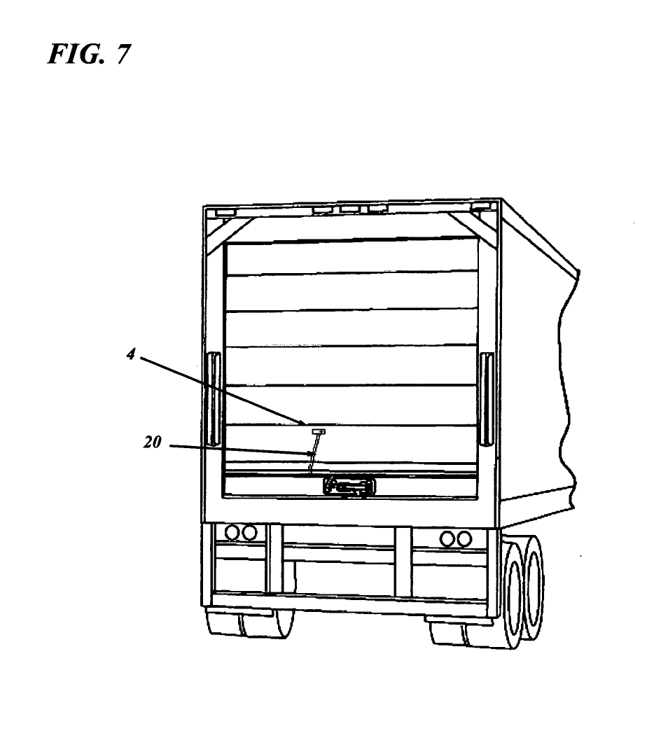

The handle assistance device of the present invention can be affixed to a newly fabricated pull cord as part of a new installation of an operable device or may be retrofitted to a pre-existing pull cord/operable device combination. In practice, the handle assistance device having the free end of a pull cord retained therein is used by an operator to activate or engage the relative operable device. Upon completion of the activation or engagement of operation, the handle assistance device is positioned proximal to a ferrous metallic object whereby the ferrous metallic object is in a position that is out of the way of potential harm to the pull cord itself (FIG. 7). This location can include a ferrous metallic element of the operable device itself (i.e. on an element of a mechanical-type roller door or the related framework), a ferrous metallic object that is unrelated to the operable device (i.e. to a close by metal rack cross bar), or to a purpose-specific ferrous metallic object intended specifically to receive the handle assistance device (i.e. a small footprint steel plate affixed to a wall).

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A handle assistance device for a pull cord, comprising;
a. a pull cord having an end affixed to an operable device and a free end which is engaged by an operator in order to use said operable device;
b. a grasping handle;
c. a cord retention element for receiving said free end of a pull cord;
d. a first magnetic pad;
e. a ferrous surface;
wherein said handle assistance device is attached to said free end of said pull cord by said cord retention element;
wherein said grasping handle of said handle assistance device is configured for applying a pulling force to said pull cord; and
wherein said first magnetic pad is integrated into said handle assistance device such that said handle assistance device and attached free end of said pull cord can be temporarily affixed by magnetic attraction to said ferrous surface.

2. A handle assistance device as in claim 1, wherein said pull cord has a cross-sectional profile that is essential round.

3. A handle assistance device as in claim 1, wherein said grasping handle has a profile aligned perpendicular to said pull cord.

4. A handle assistance device as in claim 1, wherein said cord retention element is a hole extending through said handle assistance device.

5. A handle assistance device as in claim 1, wherein said magnetic pad is a rare-earth magnet

6. A handle assistance device as in claim 1, wherein said handle assistance device further includes a second magnetic pad whereby said second magnetic pad and said first magnetic pad are on the same side of said handle assistance device.

7. A handle assistance device as in claim 1, wherein said handle assistance device further includes a second magnetic pad whereby said second magnetic pad and said first magnetic pad are on opposite sides of said handle assistance device.

8. A handle assistance device as in claim 1, wherein said handle assistance device further includes an attention garnering function.

9. A handle assistance device as in claim 8, wherein said attention garnering function is a visual alert.

10. A handle assistance device as in claim 8, wherein said attention garnering function is an auditory alert.

11. A method for using a handle assistance device, comprising;
a. A handle assistance device, comprising
i. a pull cord having an end affixed to an operable device and a free end which is engaged by an operator in order to use said operable device;
ii. a grasping handle;
iii. a cord retention element for receiving said free end of a pull cord;
iv. a first magnetic pad;
b. a ferrous surface;
wherein said handle assistance device is attached to said free end of said pull cord by said cord retention element;
wherein said grasping handle of said handle assistance device is configured for applying a pulling force to said pull cord; and
wherein said first magnetic pad is integrated into said handle assistance device such that said handle assistance device and attached free end of said pull cord can be temporarily affixed by magnetic attraction to said ferrous surface.

12. A method of using a handle assistance device as in claim 11, wherein said ferrous surface is an element of said operable device.

13. A method of using a handle assistance device as in claim 11, wherein said ferrous surface is a separate ferrous surface intended specifically to receive said handle assistance device.

14. A method of using a handle assistance device as in claim 11, wherein said handle assistance device further includes an attention garnering function.

15. A method of using a handle assistance device as in claim 14, wherein said attention garnering function is a visual alert.

16. A method of using a handle assistance device as in claim 14, wherein said attention garnering function is an auditory alert.
